(19) United States
(12) Patent Application Publication
(10) Pub. No.: US 2011/0006854 A1
(43) Pub. Date: Jan. 13, 2011

(54) WAVEGUIDE COUPLER

(76) Inventor: Takayuki Oyama, Tokyo (JP)

Correspondence Address: Mr. Jackson Chen, 6535 N. STATE HWY 161, IRVING, TX, 75039, US

(21) Appl. No.: 12/921,711

(22) PCT Filed: Mar. 10, 2009
(86) PCT No.: PCT/JP2009/054975

§ 371 Date: Sep. 9, 2010

(30) Foreign Application Priority Data
Mar. 17, 2008 (JP) 2008-067274

(51) Int. Cl. H01P 5/18

(52) U.S. Cl. 333/114

(57) ABSTRACT

Provided is a short-slot type waveguide coupler which can be applied to a transmission line that transmits broadband signals.

The waveguide coupler according to the present invention is a short-slot type waveguide couplers wherein it includes a plurality of waveguide units which have a separate port for inputting or outputting signals respectively and a joint unit which combines a plurality of waveguide units and have a specific length in a predetermined direction. Here, at least one waveguide unit extends to a direction that forms a predetermined angle from a longitudinal direction of the joint unit.

### TECHNICAL FIELD

The present invention relates to a short-slot type waveguide coupler.

### BACKGROUND ART

In recent years, short-slot type waveguide couplers are widely used in microwave circuits. An example of the short-slot type waveguide coupler is shown in FIG. 5. The short-slot type waveguide coupler 100 shown in FIG. 5 is configured by connecting two rectangle-type waveguides at common planes and removing a part of the common planes and making it as a joint unit. Here, it defines waveguide unit 111, 112, 113, and 114 corresponding to a part from four ports 131, 132, 133, and 134 to the joint units 121 respectively of these two rectangle-type waveguides. In this case, for example, a signal of TE10 (Transverse Electric) mode that is inputted from the port 131 to the waveguide unit 111 excites a signal of TE20 mode in addition to TE10 mode at the joint unit 121. Further, the signals of two modes are distributed according to a phase difference between the modes which is settled by a length of joint unit 121 and a signal incident angle or the like. For example, when it sets the phase difference of TE10 mode and TE20 mode to 90 degrees, the signal inputted from the port 131 is equally distributed both to the port 133 and to the port 134. On the other hand, when it sets the phase difference to 180 degrees, a signal inputted from the port 131 is outputted only to the port 134.

Here, in the waveguide coupler 100 shown in FIG. 5, a matching element 122 for adjusting coupling degree and impedance among the waveguide units 111, 112, 113 and 114 is arranged at the joint unit 121. By arranging the matching element 122, it is able to decrease VSWR (Voltage Standing Wave Ratio). VSWR is a value representing degree of generating a reflection signal at a mismatching part of impedance, and it is desirable to minimize the value. In addition, when there is no reflection at all, the value is VSWR=1.

As an example, a short-slot type waveguide coupler 100 that is shown in FIG. 5 is disclosed in FIG. 2 of the Japanese Patent Application Laid-Open No. 1999-330812 and in FIG. 6 of the Japanese Patent Application Laid-Open No. 1998-126118.

### DISCLOSURE OF THE INVENTION

### Problem to be Solved by the Invention

However, in a case of the short-slot type waveguide coupler 100 shown in FIG. 5, a phase difference between modes at a signal in a frequency band away from a center frequency of a desired bandwidth seriously deviates from a desired range and cannot meet a better impedance matching. When the phase difference deviates from the desired range, the signal is not distributed at a desired ratio. In addition, when the impedance is mismatched, the signal is reflected. Accordingly, it cannot apply it to a transmission line that carries broadband signals.

The object of the present invention is to be made in view of the above-mentioned circumstances, and provide a short-slot type waveguide coupler which can be applied to transmission lines that carry broadband signals.

### Means for Solving the Problem

In order to achieve the above-mentioned object, the waveguide coupler of the present invention is a short-slot type waveguide coupler which includes a plurality of waveguide units that have ports for inputting or outputting signals respectively, and a joint unit that combines plurality of the waveguide units and has a specific length in a predetermined direction. Here, at least one waveguide unit extends to a direction that forms a predetermined angle from a longitudinal direction of the joint unit.

### THE EFFECT OF THE INVENTION

According to the present invention, it can provide the short-slot type waveguide coupler which can be applied to transmission lines that carry broadband signals.

### BRIEF DESCRIPTION OF DRAWINGS

The above-mentioned object and other object, a feature and an advantage will become more apparent by the following preferred embodiments and accompanying drawings thereof.

FIG. 1 A perspective diagram showing a composition of the waveguide coupler 10 according to the first embodiment

FIG. 2A A diagram showing from right above of a section of the waveguide coupler according to a related art

FIG. 2B A diagram showing a state that the waveguide unit 13 is rotated by angle of α degrees from a straight line AA′ in the waveguide coupler in FIG. 2A.

FIG. 2C A diagram showing from right above of a section of the waveguide coupler 10 according to the first embodiment

FIG. 3 A perspective diagram showing a composition of a waveguide coupler 10B according to the second embodiment

FIG. 4 A perspective diagram showing a composition of a waveguide coupler 10C according to the third embodiment

FIG. 5 A perspective diagram showing a composition of the waveguide coupler 100 according to a related art

### REFERENCE SIGNS LIST

10, 10B, 10C, and 100 waveguide coupler
11, 12, 13, 14, 11C, 12C, 13C, 14C, 111, 112, 113, and 114 waveguide unit
21, 21C, and 121 joint unit
22, and 122 matching element
31, 32, 33, 34, 31C, 32C, 33C, 34C, 131, 132, 133, and 134 port

### BEST MODE FOR CARRYING OUT THE INVENTION

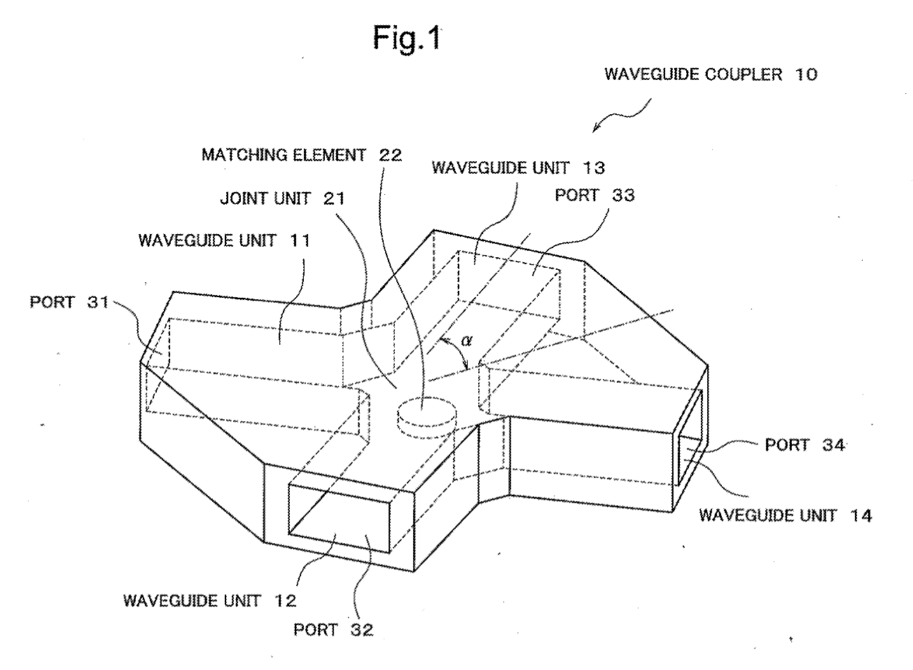

An embodiment for carrying out a present invention will be described in detail. FIG. 1 is a perspective diagram of a short-slot type waveguide coupler 10 according to a first embodiment. In FIG. 1, the waveguide coupler 10 mainly includes four waveguide units 11, 12, 13, and 14, and a joint unit 21. In the embodiment, the waveguide units 11, 12, 13, and 14 are formed in rectangular shape respectively. The waveguide units 11, 12, 13 and, 14 have ports 31, 32, 33, and 34 respectively for inputting or outputting signals. The joint unit 21 mutually combines four waveguide units 11, 12, 13, and 14. Further, in the embodiment, a matching element 22 is arranged in the joint unit 21.

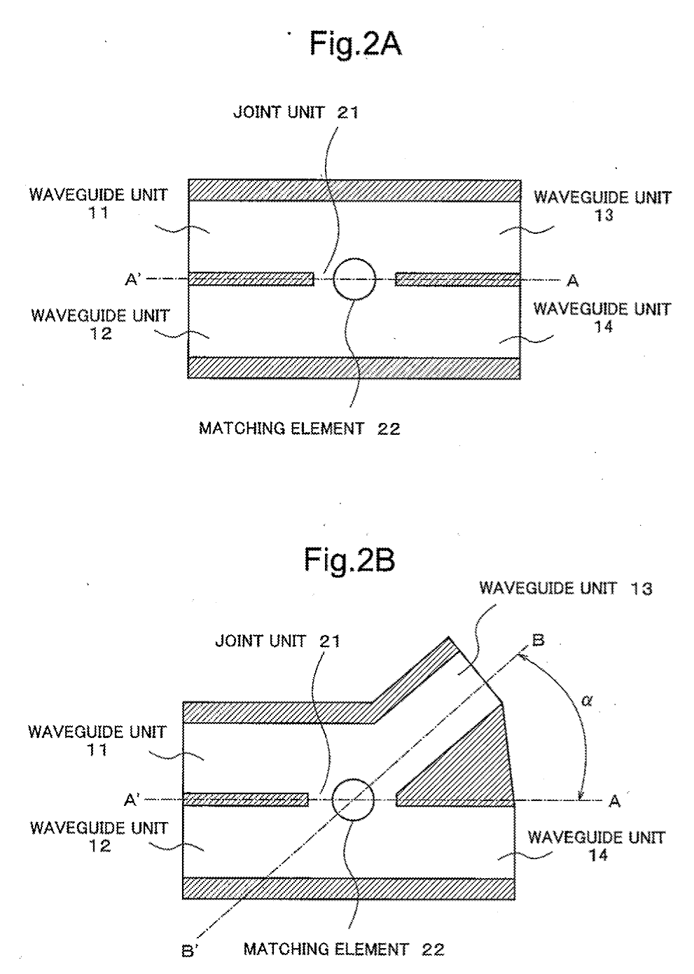

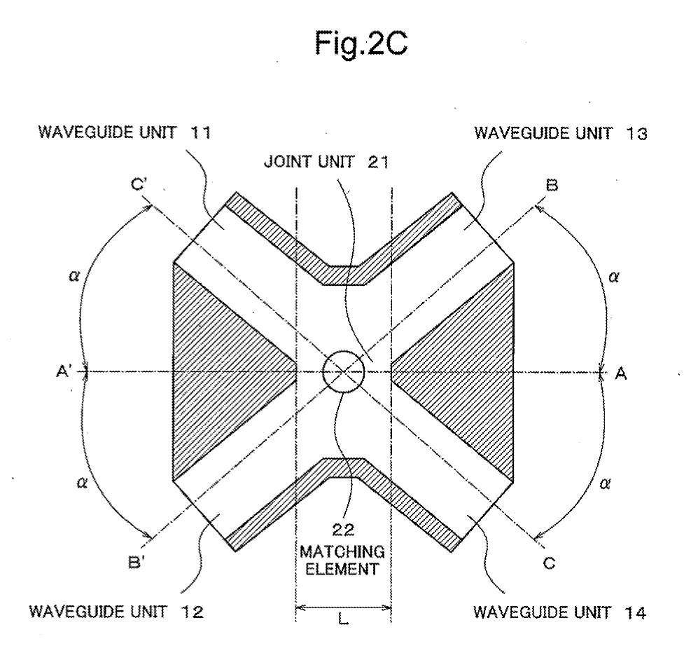

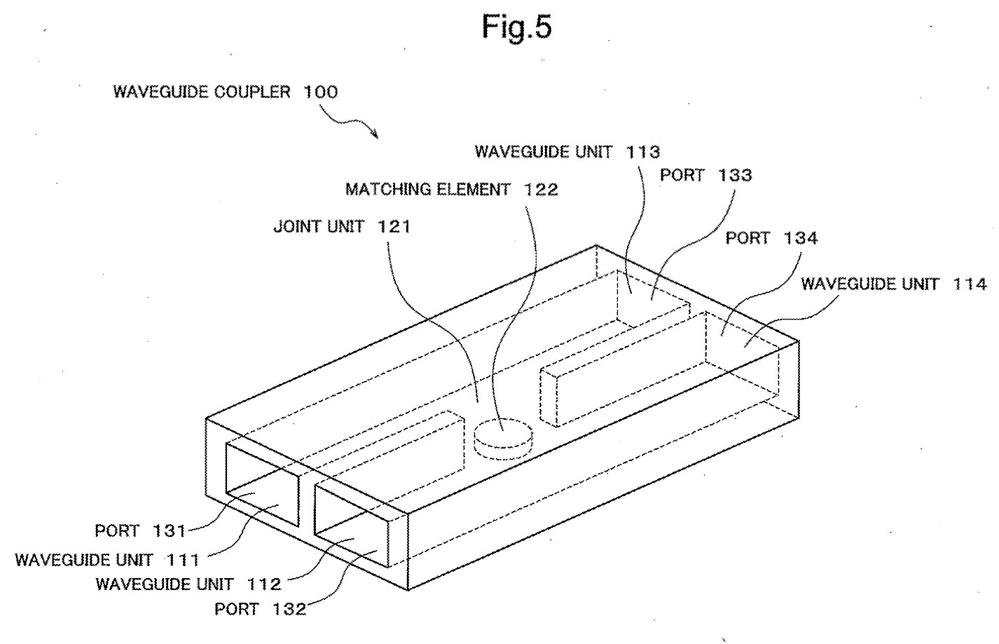

It will describe the structural difference between the waveguide coupler 10 according to the embodiment and the waveguide coupler 100 according to the related art which is indicated in the background art (i.e. FIG. 5) using FIG. 2A, FIG. 2B, and FIG. 2C. FIG. 2A is a diagram showing from right above of the section of the waveguide coupler which has the same structure as the waveguide coupler 100 according to the related art. FIG. 2B is a diagram showing a transformation process from the waveguide coupler in FIG. 2A into the waveguide coupler according to the embodiment. FIG. 2C is a diagram showing from right above of a section of the waveguide coupler 10 according to the embodiment.

In FIG. 2A, the waveguide units 11, 12, 13, and 14 are extended to the same directions. Single side of the waveguide units 11, 12, 13, and 14 are mutually connected by the joint unit 21.

Here, a straight line AA′ is a straight line (hereinafter, referred to as a virtual straight line AA′) passing through the joint unit 21 and in parallel with a lengthwise direction of the waveguide units 11, 12, 13, and 14. Then, the lengthwise direction of the waveguide units 11, 12, 13 and, 14 in FIG. 2A is corresponding to a predetermined direction of the claims.

In FIG. 2A, if the waveguide unit 13 is rotated by angle of α degrees to a counter-clockwise direction from the virtual straight line AA′, it will become FIG. 2B. Further, in the embodiment, the angle is set to α=40 degrees. In FIG. 2B, suppose that a straight line BB′ is a straight line in parallel with the lengthwise direction of the waveguide unit 13 and passing through the joint unit 21, then it forms angle of α=40 degrees between the virtual straight line AA′ and the straight line BB′.

Further, in FIG. 2B, if both the waveguide unit 11 and the waveguide unit 14 are rotated by angle of α degree to a clockwise direction from the virtual straight line AA′ and the waveguide unit 12 is rotated by angle of α degree to a counter-clockwise direction from the virtual straight line AA′, it will become the waveguide coupler 10 according to the embodiment shown in FIG. 2C. In addition, it set to angle of α=40 degrees for the both cases. In FIG. 2C, a straight line CC′ is a straight line passing through the joint unit 21 and in parallel with the lengthwise direction of the waveguide unit 11 and the waveguide unit 14.

The waveguide coupler 10 in FIG. 2C, which is mentioned above, excites a signal of TE20 mode in addition to a signal of TE10 mode at the joint unit 21, to a signal of TE10 mode which is inputted from the waveguide unit 11, as an example. Further, two mode signals are distributed based on a distribution ratio according to the phase difference between modes that is decided by a length L (FIG. 2C) which is in the parallel direction with the virtual straight line AA′ of the joint unit 21.

According to the embodiment of the waveguide coupler 10, the length L in the direction of the virtual straight line AA′ of the joint unit 21 is adjusted in order that the signal phase difference of two modes is about 90 degrees. In this case, electric power of the 3 dB is supplied to the waveguide unit 13 and the waveguide unit 14 respectively. That is, a signal inputted from the waveguide unit 11 is equally distributed among the waveguide unit 13 and the waveguide unit 14, and are outputted. Further, because signal of two modes are offsetting, no signal is outputted from the waveguide unit 12.

Here, when the waveguide unit extends to the direction that is rotated by a predetermined angle from the virtual straight line AA′ which is equal to the direction (predetermined direction) of the length L of the joint unit 21, comparing with a case that the waveguide unit extends to the predetermined direction, it can decrease a shift from the desired value of the phase difference between the modes in the signal whose frequency band is away from the center frequency of the desired bandwidth. In this case, even for a signal whose frequency band is away from the center frequency, it can keep the phase difference of the signal TE10 mode and TE20 mode that propagates the joint unit 21 within a desired range, and the signal is distributed appropriately. In addition, impedance matching characteristics between the joint unit and the waveguide unit can be improved, and it can decrease reflection of the signal. Accordingly, the short-slot type waveguide coupler can be applied to the broadband signal.

Then, it describes a comparison result in a case that, the waveguide coupler (hereinafter, referred to as the embodiment 1) in which each four waveguide units rotate respectively by angle of α=40 degrees from the virtual straight line AA′, and the waveguide coupler (referred to as the comparative example 1) in which four waveguide joint units extend in a predetermined direction. In a case that a frequency bandwidth ratio is 10% and a coupling degree is −10 dB, then the coupling degree is −10 dB+/−1 dB and VSWR is no more than 1.2 for the waveguide coupler according to the comparative example 1. On the other hand, in case of the waveguide coupler according to the embodiment 1, the coupling degree is −10 dB+/−0.1 dB and VSWR is no more than 1.07. By adopting a structure of the waveguide coupler according to the embodiment as mention above, a signal that is away from the center frequency can be distributed appropriately and a deviation of the coupling degree is decreased. By decreasing the reflection of signal, the VSWR characteristic is improved.

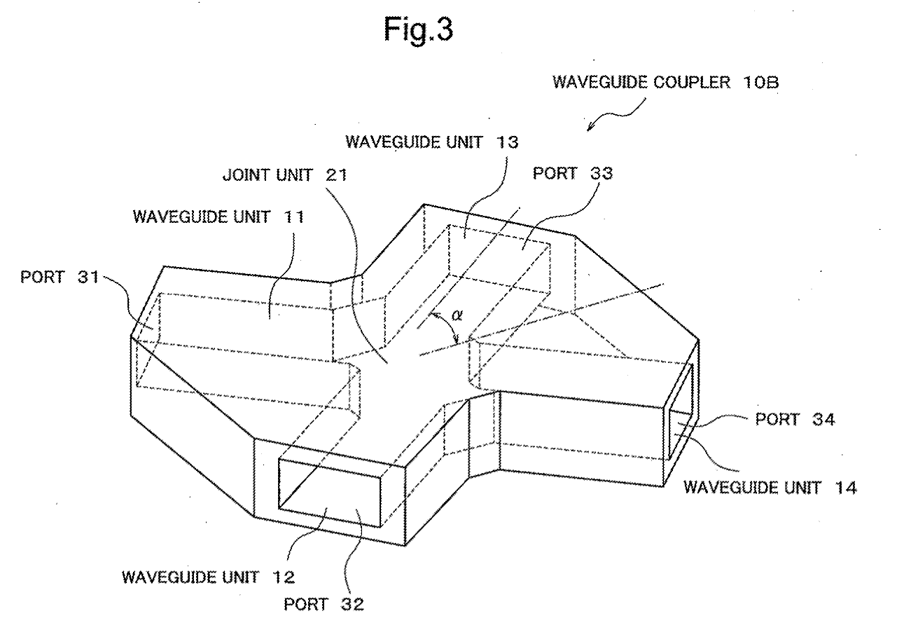

Here, the waveguide coupler does not always need to have a matching element. As a second embodiment, FIG. 3 shows a perspective diagram of the waveguide coupler 10B which is not equipped with the matching element. In case of the waveguide coupler 10B which is not equipped with the matching element, it can bring a merit of producing economically than the waveguide coupler equipped with the matching element, even though the VSWR characteristic is degraded.

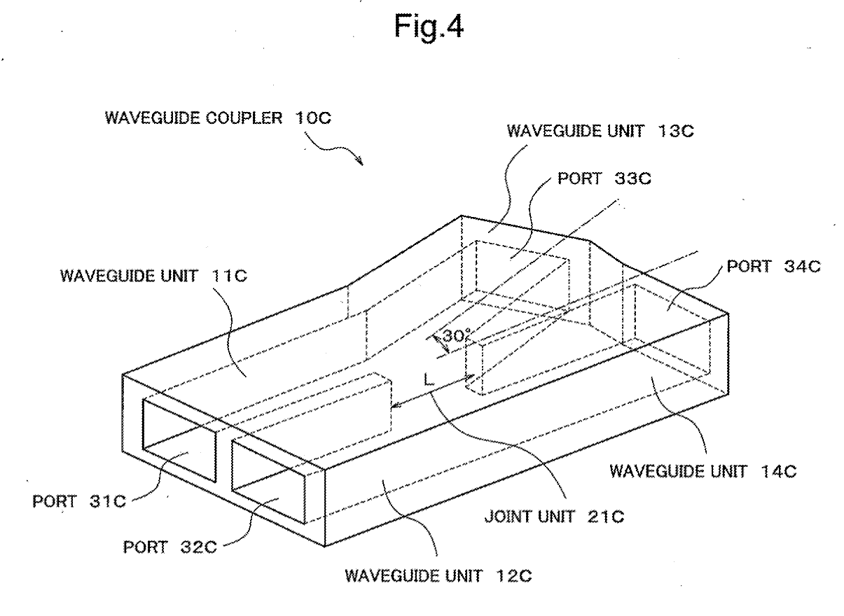

According to the first embodiment of the waveguide coupler 10, although it is rotated by angle of α=40 degrees from the virtual straight line AA′ for all four waveguide units 11, 12, 13 and 14, it does not limit to angle of α=40 degrees. Angle α should be no more than angle of 90 degrees and no smaller than angle of 15 degrees, and it should rotate at least one waveguide unit among a plurality of waveguide units. Here, when angle α is smaller than angle of 15 degrees, it cannot substantially suppress that the phase difference between the modes at the signal of the frequency band away from the center frequency of the desired bandwidth deviates seriously from the desired range. As a third embodiment, FIG. 4 shows a perspective diagram of a waveguide coupler 10C in which only a waveguide unit 13C rotates by angle of 30 degrees from the direction of the length L of a joint unit 12C. Even though a case that single waveguide unit extends in the direction to form angle of α from the direction (predetermined direction) of the length L of the joint unit 12C, if it compared with the case that all waveguide units expand to the predetermined direction, it is possible to cover broadband characteristics.

While having described an invention of the present application referring to the embodiments, the invention of the present application is not limited to the above mentioned embodiments, and the various modifications are possible in the range that does not deviate from the point.

Here, for the waveguide coupler according to the embodiment, the predetermined angle may be an angle between a first virtual straight line that is parallel to the joint unit and a second virtual straight line that is parallel to the waveguide.

In addition, for the waveguide coupler of the embodiment, the predetermined angle may be no more than angle of 90 degrees and no smaller than angle of 15 degrees.

Further, for the waveguide coupler according to the embodiment, according to the phase difference between TE10 mode and TE20 mode of the high frequency signal propagating the joint unit, outputted distribution ratio of the high frequency signal may be defined.

Furthermore, for the waveguide coupler according to the embodiment, a plurality of waveguides for the high frequency signal may have separated port for inputting and outputting respectively.

Moreover, for the waveguide coupler according to the embodiment, a plurality of waveguides may have rectangular shapes.

Likewise, for the waveguide coupler according to the embodiment, the matching element can be arranged at the joint unit.

Here, in a case that four waveguide joint units of the waveguide coupler extend in the same direction, the more the distribution ratio is increased, the more the broadband characteristics is degraded. Accordingly, it was often adopted as the equal distribution coupler of −3 dB, and the waveguide coupler having the distribution ratio such as −10 dB, which is relatively large, is rarely adopted.

In contrast, according to the present invention, it can provide a short-slot type waveguide coupler which can be applied to the broadband signals.

While having described an invention of the present application referring to the embodiments, the invention of the present application is not limited to the above mentioned embodiments. It is to be understood that to the configurations and details of the invention of the present application, various changes can be made within the scope of the invention of the present application by those skilled in the arts.

This application claims priority from Japanese Patent Application No. 2008-067274, filed on Mar. 17, 2008, the contents of which are incorporation herein by the reference in their entirety.

### AVAILABILITY IN INDUSTRY

The present invention of a short-slot type waveguide coupler is applicable to an apparatus and equipment which combine a plurality of waveguides.

1. A short-slot type waveguide coupler comprising:
a plurality of waveguide units that have ports for inputting or outputting a signal; and
a joint unit that combines said plurality of waveguide units and has a specific lengths in a predetermined direction, wherein
at least one of said waveguide units extends to a direction that forms a predetermined angle with said predetermined direction.

2. The waveguide coupler according to claim 1, wherein
said predetermined angle is no smaller than angle of 15 degrees and no more than angle of 90 degrees.

3. The waveguide coupler according to claim 1, wherein
said length is set in order that the phase difference between a signal of TE10 mode and TE20 mode which propagates said joint unit is 90 degrees.

4. The waveguide coupler according to claim 1, wherein
said four waveguide units extend to a direction that forms a predetermined angle with said predetermined direction respectively, and each single side combines with said joint unit.

5. The waveguide coupler according to claim 1, wherein
a matching element is arranged in said joint unit.
